(19) United States
(12) Patent Application Publication
(10) Pub. No.: US 2008/0040784 A1
(43) Pub. Date: Feb. 14, 2008

(54) Procedure and Multi-Key Card to Avoid Internet Fraud

(76) Inventor: Eduardo Luis Salva Calcagno, Buenos Aires (AR)

Correspondence Address: JACOBSON HOLMAN PLLC, 400 SEVENTH STREET N.W., SUITE 600, WASHINGTON, DC, 20004, US

(21) Appl. No.: 10/584,931

(22) PCT Filed: Jan. 5, 2005
(86) PCT No.: PCT/US05/00068

§ 371 Date: Aug. 29, 2006

(30) Foreign Application Priority Data
Jan. 5, 2004 (AR) P040100013

(51) Int. Cl. H04K 1/00

(52) U.S. Cl. 726/9

(57) ABSTRACT

Security procedure specifically designed to legitimize transactions and avoid Internet fraud, put into practice with the use of a Multi-key card that contains a card identification code, user NICKs and a variable number of hidden PINs that serve to enable a single operation and then become invalidated. The procedure contemplates the possibility of the user using the Multi-key card by means of the Web or by means of a Call Center, in both cases in the expectation of the authentication of his identity by the Authorization Center. The Center has an isolated database not available on line where all the sensitive data is safely stored to avoid any type of falsification. In this manner, not only the system that operates on line but the Call Center Operator of can check the information supplied by the user (card code+NICK+PIN) in the isolated database and then authorize or deny the operation, in accordance with the result of the process of the authentication of identity.

### TECHNICAL FIELD OF THE INVENTION

The present invention has to do with a security procedure specifically designed to legitimize transactions and avoid Internet fraud, usually committed by means of the theft of sensitive data, which is then utilized to carry out illicit operations. The invention also provides a multi-key card necessary to put the aforesaid procedure into practice.

### STATE OF THE ART (BACKGROUND)

Communications networks are the key to the transmission of information on the Internet, and on many other channels as well, such as mobile telephones, etc. Any interconnected system can be considered a network. In the computer field, however, the Internet is considered to be thee least secure network for users at the present time.

Proof of that is the manner in which numerous companies treat specific items of their budgets as confidential information, particularly those concerning computer network security.

It is calculated that the companies of the world have invested 6.3 billion dollars to protect their computer networks this year alone, and billing in the field is expected to more than double in the next 3 years to 12.9 billion dollars.

In spite of the few cases of computer fraud reported each year in relation to the enormous amount of real crimes committed, losses are estimated to account for as much as 2 dollars of every $1000 of products paid for.

It is worthwhile to make a brief review of the present function of the Internet to point out its weaknesses.

The basic idea of the Internet is that two computers remote from each other can establish communications, taking advantage of a physical support system. The telephone pair and the cable-modem are among the best-known adjuncts that presently supply communication linkages by means of the Internet.

In addition to physical support, there is a communications protocol, which allows all computers to “understand” each other through servers, which are large CPUs that serve a portfolio of clients to whom they provide electronic mail addresses or a space on the web, in addition to FTP or chat services, for example.

After the servers come the connection nodes or routers, which facilitate the “jumps” to be carried out until the destination is reached. These routers are systems that guide our data toward its predetermined address. As in the case of telephone numbers, each web page has a numeric assignment as an electronic address (IP), which is essential to track the connection nodes necessary. Then, the pages are read by means of a navigator installed in our computer that is capable of dialing the IP address, capable of supporting the specific protocol and of interpreting IP responses, which identify the place.

The navigator can in turn keep each part of the page downloaded, modify it or process it, in addition to sending and receiving files in conjunction with specific programs.

All these elements are enormous channels that are activated when we connect ourselves to the Internet, a procedure that we repeat routinely, submitting our password and our user name. These two basic bits of data are authenticated by our server to validate our connection and access, which gives us “the right” to carry out operations we have agreed to beforehand with our server.

So, if data can travel from one place to another, it is also possible to carry out other types of operations, such as the exchange of files between computers. This is accomplished by means of FTP, a communications standard that allows the “reading” of the hard disk of another computer at a distance and downloading all or part of it, with prior authorization.

On the other hand, with FTP we can also send any file from our hard, disk to another hard disk in a distant computer. And this is where the problems of Internet security begin since this mode penetrates the system and obtains access to passwords.

These days we habitually read news in the media related to computer fraud resulting from the activities of hackers, crackers lamers, copy hackers and other members of the “family” of electronic delinquents. All of them are catalogued as “computer pirates” and it is not necessary to go into the details of the more common operations of each one of these groups to enumerate the most damaging results of their action, to wit:
Theft of sensitive data from databases placed on the Internet.
Falsification of identity, duplication of identity.
Commercial operations on the Internet that utilize stolen data.
Duplication of credit, debit and other types of cards.
Falsification of documents: real estate deeds, credits, loans, bank statements, etc.

We have only listed that which concerns us in the area of the unresolved problem the present invention addresses, which is the theft of sensitive data from the network and its later utilization in fraudulent commercial operations. It is not the goal of this invention to avoid the propagation of viruses or the cracking of systems by Internet.

In the face of the insecure situation the web now offers in carrying out operations that imply commercial transactions, computer companies have come up with certain responses: the installation of firewalls, the encryption of data in their more complex models and other types of defenses that we are not going to enumerate in detail. We simply want to point out that in all cases, there are two “points” in the system: the one from where the information is sent and the point at which the information is received and stored. All solutions available to present technology impede, or limit to the maximum, access to databases that contain the sensitive information that makes it possible to carry out the sorts of fraud that we have mentioned. All efforts against computer pirates have concentrated on this two-point system, strengthening it to the maximum and encrypting the data in an effort to make access and later use of the information by the hacker as difficult as possible. In spite of all that, these solutions have not given the result hoped for. Merely reading the newspapers is enough. The news features million-dollar swindles and frauds committed in prejudice to multinational corporations or to individual clients who discover that their credit card has been cloned and their name utilized falsely by means of the web.

This occurs because, in the two-point system utilized at the present time, the database is always available in an accessible network, whether by means of modem or on line, and the hacker can therefore steal the data from one point, for example a PIN or NICK from a specific user's card and then, with that information operate on the accessible database, which will recognize the permissions as “good” and enable the computer delinquent to begin his criminal undertakings.

So, what would happen if the present two-point system is changed and one of the two points, the one which houses the sensitive data, is isolated in such a way that it would not be available in a network; while the other point, the one that contains the permits, remains isolated as a series of unconnected data, the theft of which would be useless without the database on which it would have to operate?

The goal of the present invention patent is to resolve the problem that has arisen in prior art by a procedure that modifies known operational stages, isolating the database of the accessible network and introducing a Multi-key security card that does not allow two operations to be carried out utilizing the same PIN number. This is accomplished by means of a PIN number confirmation system.

The security and safeguard that this Multi-key security card affords when utilized in the procedure claimed consists of the fact that it is never known beforehand what next PIN or alphanumeric code the client who has the Multi-key security card will use in his next transaction.

For that reason, the hackers cannot make use of stolen, adulterated or falsified cards since it is the owner himself who legitimizes the purchase, as will be spelled out below, each time he utilizes a new PIN.

Moreover, this procedure eliminates the possibility that the user may inadvertently provide sensitive information about his credit or debit card, such as the account number itself and all the data that makes up his identification in the accessible network, as is done in any Internet operation at the present time. The only thing to which the computer thief will be able to gain access is the last PIN number utilized but he will not know with whom the account is associated or what PIN the client will use next, since the last one used was automatically voided and discarded from the confirmation system.

In summary, we could say that, at the present time, there are two types of identifiers utilized in electronic operations:

Intrinsic: DNA imprint, background eye scan, iris, fingerprints, physiognomy of the hands, voiceprint, kinetics of the handwritten signature, etc.

Extrinsic: PINs, passwords, handwritten signature, historic data, bank account numbers, etc.

The security of extrinsic identifiers, once utilized, is compromised because the system allows them to be contained in databases accessible by means of the Web, for example:

### PIN Numbers

Are typical cases of an extrinsic identifier.
Are the methods utilized in magnetic tape cards.
Are a secret shared between the authorized user and the system.
The PIN must be introduced into the system before the card can be utilized.
The level of security that it provides is really weak.
The PIN only provides protection from attackers technically ill-informed and without resources.
The user does not choose a really unimaginable number, but one that tends to be a number easy for him to remember.
In the case of such scenarios as the Internet: Once the PIN is introduced on insecure equipment, it can be captured and re-used, making it totally vulnerable to the network and to commerce by means of the network.

The security of the procedure proposed is based on a series of components, which in combination produce a secure product, novel and inventive in comparison to the present state of the art.

Said components are:
OTP (One Time Password) Concept, which means that, once utilized, a password cannot be used again and the capture of such data is of no value to anyone.
Biometric authentication of the identity of the person who receives the card that contains the codes to be used (by means of fingerprints, signature and his DNA).
Authentication of user identity by the combined use of two codes (the user's NICK+a random PIN,) that the user knows because they are printed on his Multi-key card, plus the knowledge of the business with regard to which he is going to carry out the transaction (this last information is what invalidates the use of the card when it is lost).

And the most important,
Total Protection of the client's sensitive data (personal data, bank accounts, payments, etc.) by placing it in a database not accessible to the network.

### BRIEF DESCRIPTION OF THE FIGURES

FIG. 1 shows the flow diagram of the initial phase of tuning Business X up to operate with the Authorization Center.

FIG. 2 consists of the data entry and updating stage of Business X users.

FIGS. 3A and 3B show the process of requesting and delivering Multi-key cards to Business X by the Authorization Center and by Business X to their users.

FIGS. 4A and 4B detail the process of generation of Multi-key cards.

FIGS. 5A and 5B show the flow diagram of identity authentication by means of a Web page.

FIG. 6 shows the flow diagram of the authentication identity by means of a Call Center.

FIG. 7 shows the later action of a user, once his identity has been authenticated.

FIGS. 8A and 8B show the configuration of the multi-key card utilized in the procedure proposed.

### DETAILED DESCRIPTION OF THE INVENTION

The procedure proposed is carried out by means of a Multi-key card that is delivered to the user, which the user can utilize to carry out Internet operations that he finds appropriate.

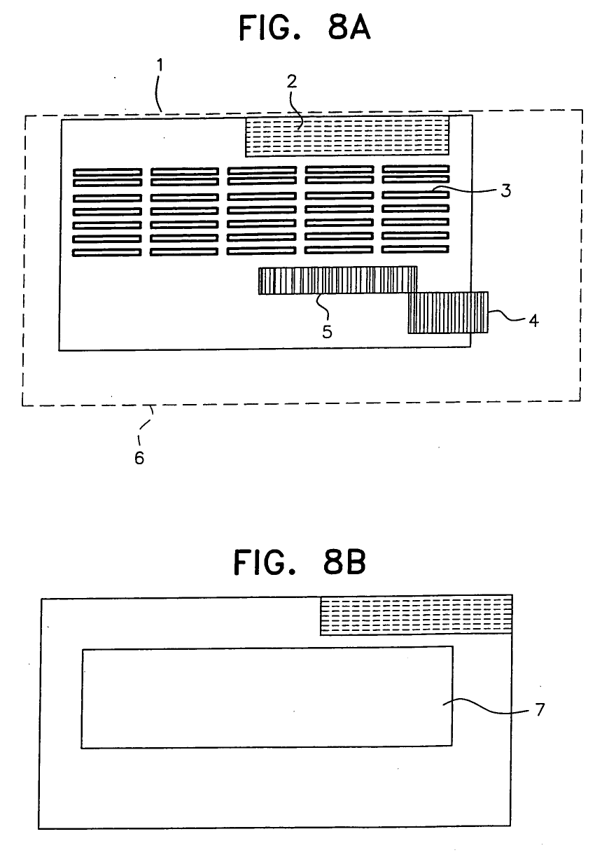

This flexible plastic card (FIGS. 8A and 8B), the usual size of magnetic cards has various particularities which make it different from cards known to the art: It does not have the user's personal data, nor the name, address or identification of the company to which it belongs or with which the aforesaid card can operate.

The user's NICK 2 is printed on the back of the card, printed hidden under a protective scratch-off coating. An alternative version would have the NICK printed on an opaque removable plastic strip so that the user could pull it off and stick it on the front of his home PC, for example, from which he will operate with his Multi-key card.

A variable series of PINs 3 (alphanumeric codes) are printed on the central part of the card, the standard model of which contains 30 to 50 PINs. Depending upon the utility to be given to the Multi-key card, it is possible that there will be special models of such cards. These PINs are all hidden under a protective scratch-off coating that the user will be scratching off as he utilizes the card. He uncovers a PIN, uses it and, once uncovered and used, the PINs are disqualified for another operation.

Other data included on the Multi-key card are the unique item code identification 4 issued by the Authorization Center press at the time of generating a specific set of cards for Business X, and a card identification code 5 consisting of a unique alphanumeric code of X (standard 10) characters, that identify that specific Multi-key card, relating it to the user and to the PINs he is authorized to use.

The front of the card may contain advertising space 7 and other less relative data, for example the date of issue of the card and the expiration date.

The Multi-key card comes heat-sealed in cellophane 6 to avoid rubbing and scratching that might uncover the hidden NICK+PIN codes.

As may be noted, another additional security standard that the procedure claimed provides, in addition to a process of user identification by fingerprint that will be described below, resides in the fact that the card does not carry identifying data that could be of use to a possible thief who might steal the card from the user. There is no way to relate the card to the user or to Business X that provided him with it, since all the information that is found contained in the database is not accessible on the Web. For that reason, a stolen card will not be of use to anyone other than its legitimate holder.

To reveal the procedure that we wish to protect, it is necessary in the first instance to describe the different entities that take part in the transaction.
Business X: Is the entity that carries out electronic banking services, payment systems and/or electronic commerce, among other services. They offer such services on the Internet and/or through a Call Center, and need to provide security to their users.
User: Is the individual who desires to utilize the services offered by Business X by means of the Internet or a Call Center.
Authorization Center (AC): Is the entity that offers the service to Business X of authorizing the user so that he can utilize the services offered by Business X in a secure manner. The Authorization Center is the entity that carries out the procedures of the generation of cards, assignment of aliases or NICKs to users and authorizes the cards for them to use.
Call Center: Is the entity that offers the service of authorizing the users of Business X by means of a telephone call. (Located in the Authorization Center, a part of it).

### Description of Procedure's or Phases

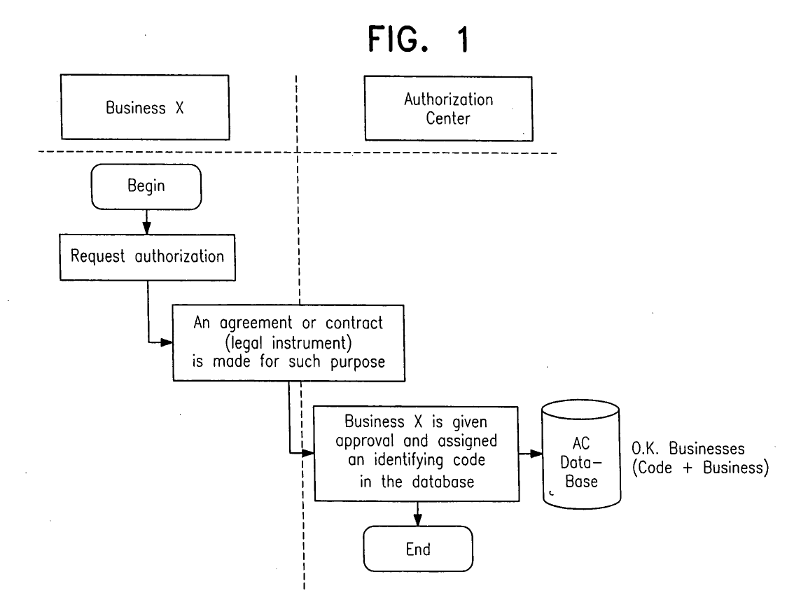

Phase 1 (FIG. 1)—Business X's Steps to Operate with the Authorization Center (AC)

Business X decides to adhere to the security system utilized by the procedure claimed and contacts the Authorization Center to the effect of signing a adherence agreement.

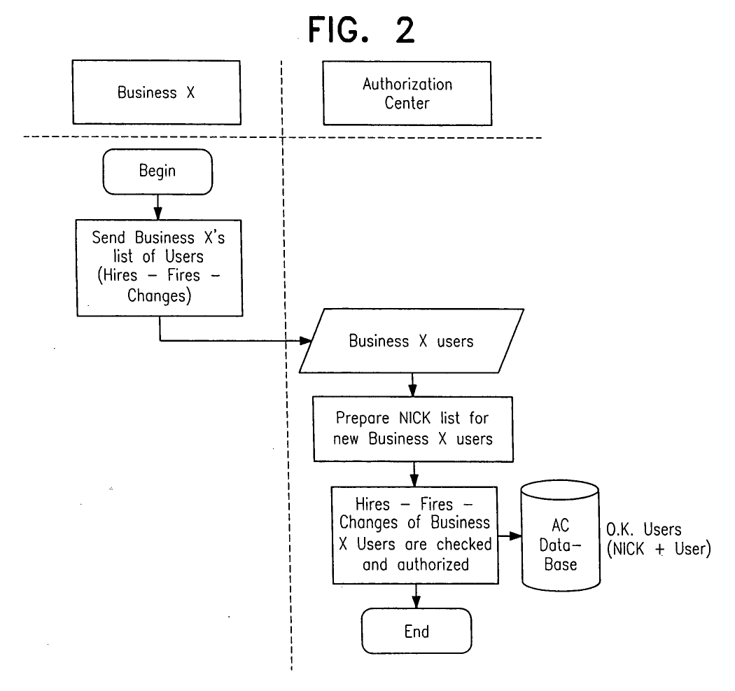

The Authorization Center enters Business X's data of into their database, which is isolated, disconnected and not available on the Web, and assigns it a unique a code for identification. At this time Business X will have to send the information about the users who will be using the security system.
Phase 2 (FIG. 2): Entry and Updating of Business X User Data

Business X sends the information with regard to the new users who are going to make use of the system. This phase also considers the case of the notification of the user changes or dismissals that are produced when Business X is operating with the system.

As of the reception of user news the Authorization Center will prepare the NICK Business X user registry assigning each user an alias or NICK that unequivocally identifies them and safeguards their identity. The Authorization Center updates its Database entering new users with a NICK associated with each one and updating or eliminating corresponding users in accordance with the information reported by Business X.

Up to this point, no data is available on the Internet, since the database with the NICKS assigned is not available on the network and if Business X has sent the list of users by Internet and not by mail or CD-Rom, this information would be valueless, since it is just a list of persons without association to and account whatsoever.
Phase 3: Requesting of Multi-key Cards by Business X and the Later Generation of Such Multi-key Cards.

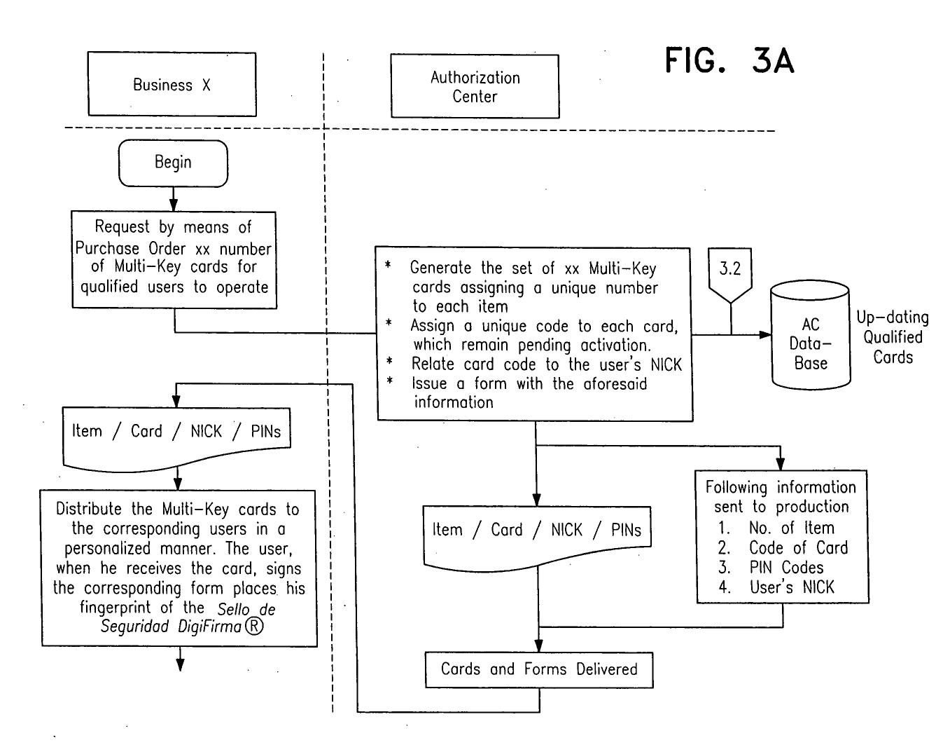

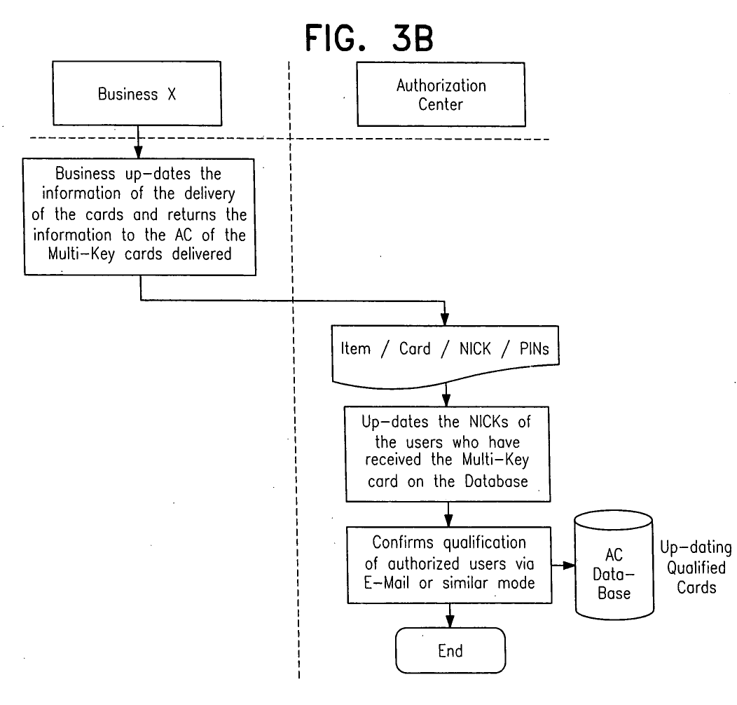

3.1 (FIG. 3): Requesting of Multi-key Cards by Business X

Business X requests Multi-key cards for their users by means of a Request Note or Purchase Order to the Authorization Center. The Authorization Center generates a set of cards that it delivers to Business X, which distributes the cards to individuals. The user receives the card and has to authenticate his identity by a signature and an organic security seal as divulged in U.S. Pat. No. 6,659,038 incorporated herein by reference.

This security seal, commercialized under the trademark DigiFirma ®, consists of a support capable of saving the fingerprint and the DNA of the person entered, extracted from his fingerprints by means of reagents and microscopic readings that can pick up organic remains from cells stuck in the organic security seal adhesive.

This organic security seal is of vital importance to avoid a type of fraud very common at the present time: identity theft.

With present systems of distribution, with a falsified document a criminal can easily make himself pass for another person and in that manner obtain, for example, a multi-key card such as those which are divulged in the present invention patent. The falsifier will receive his card in the mail and sign the mail receipt with a false signature, the same as he uses in his false identity, by means of which he can commit all types of fraud until the person whose identity was stolen detects the crimes. And by that time, the card may have been used until exhausted and the consequences will be irreparable.

In the procedure proposed and thanks to the aforementioned security seal. Business X has previously requested by means of a written order, the Multi-key cards for a list of specific users. The Center of Authorization will to the list to generate a set of cards that it will deliver to Business X, which will distribute them to individuals. This delivery is carried out by means of a specific form that included aforementioned organic security seal, so that the user is obliged to furnish his fingerprint and his DNA in the aforesaid seal, which, sent again to the Authorization Center, shall be entered in the Database, relating the identity, fingerprints, NICK, card code identifier, PINs to be used and other user-associated data.

In this manner, security measures are added that make the procedure proposed much more effective than the, systems known to the state of the art, avoiding possible fraud at the initiation of the procedure by identity theft, since if some user should want to carry out some type of crime with the Multi-key card, he would be immediately identified since he had been obliged to leave his fingerprint on the form at the time he received the multi-key card.

Once the cards have been distributed Business X will inform the AC to activate the NICK of the users who have received the Multi-key card in the Database so that such users can to make use of the cards.

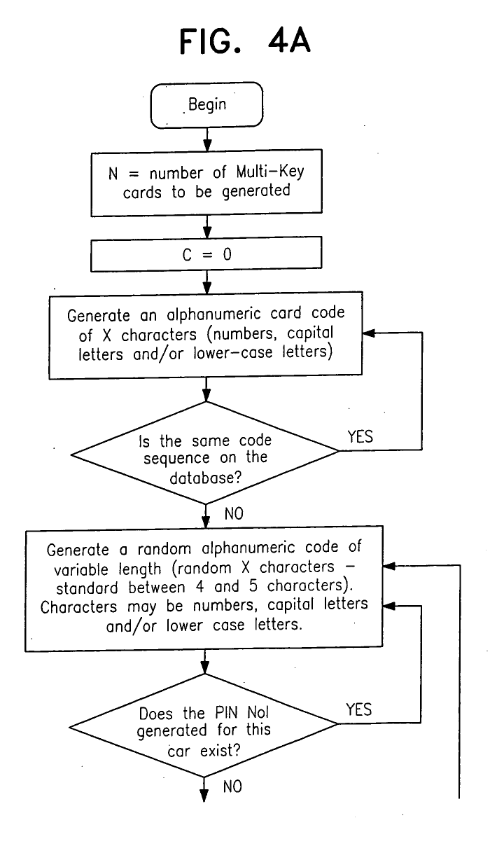

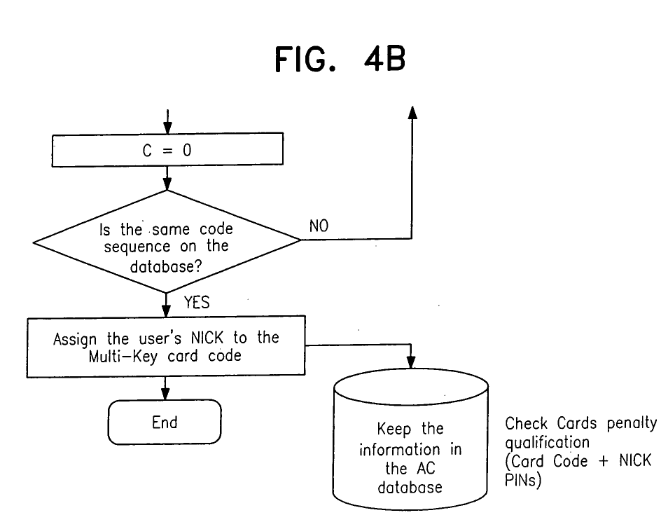

3.2 (FIG. 4): Generation of Multi-key Cards

The Authorization Center generates the cards in sets assigning each card a unique alphanumeric card identification code of X characters (numbers, capital letters and/or lower-case letters), user NICKs and a quantity of PINs to be defined. The process of generation verifies that a PIN is not repeated in the same card.
Phase 4: Authentication of Identity

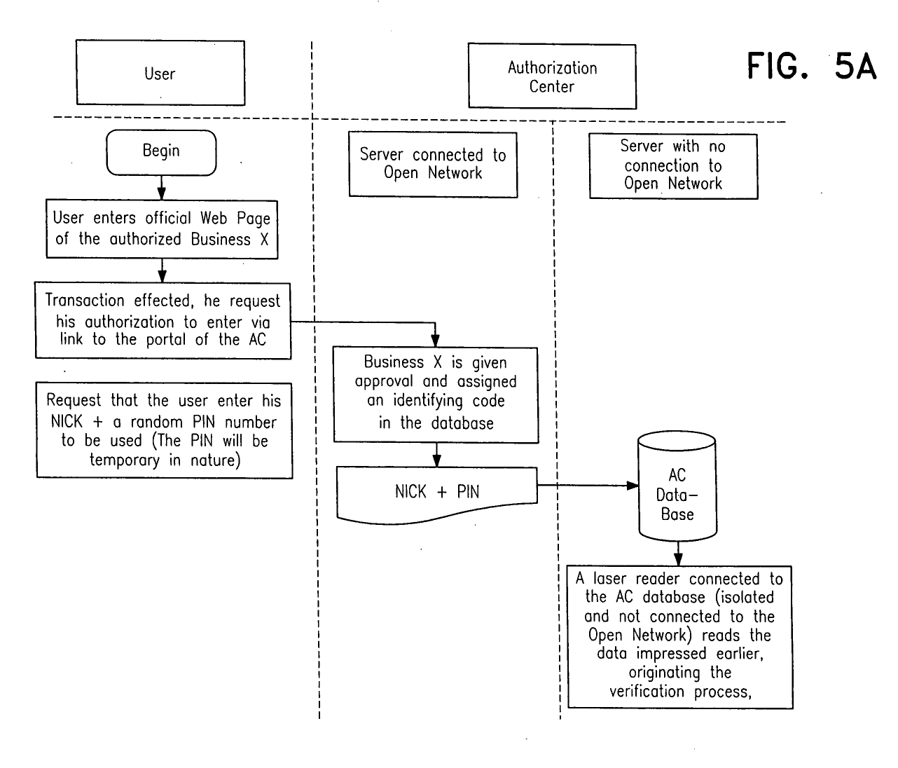

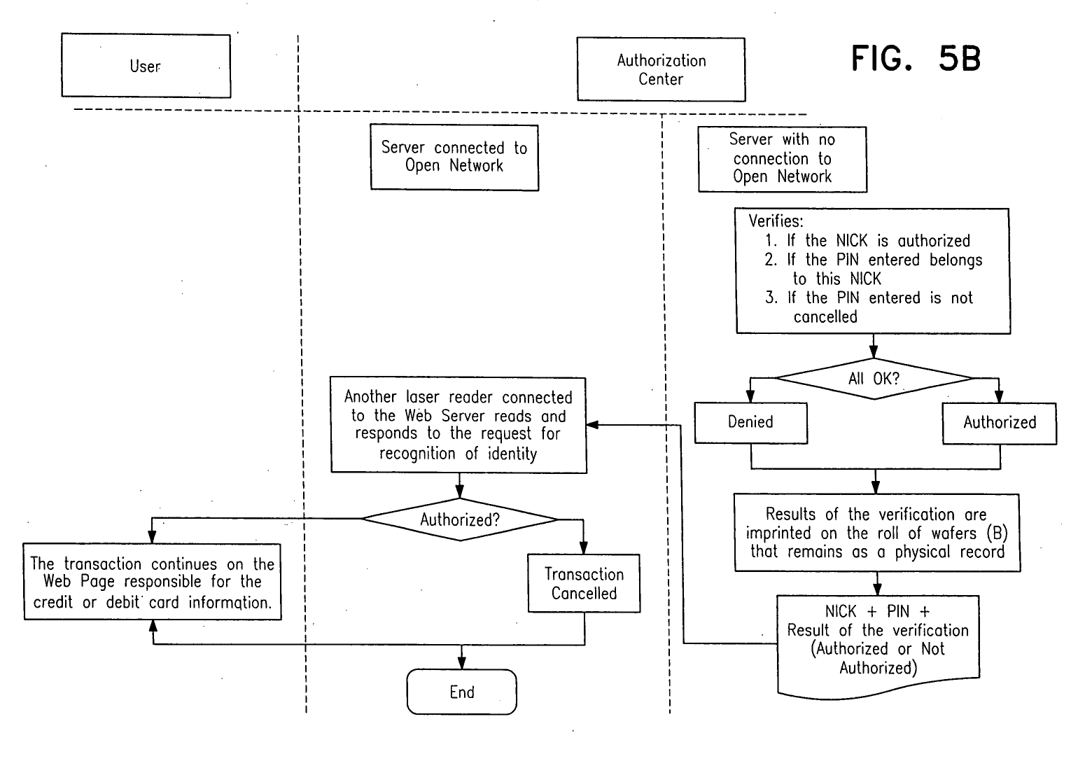

This is the phase in which the user, with his Multi-key card, utilizes electronic banking services, payment systems or indulges in electronic commerce and other services offered via the Internet. To do so, he has two routes: either entering the Business X web page or making a telephone call to the Call Center. The two possibilities are detailed below.
4.1 (FIG. 5): Authentication of Identity by Means of the Web Page

The user enters the Business X Web page and requests their recognition to enter by means of a link to the Authorization Center portal.

In this instance, the AC Web server requests that the user enter his NICK+a PIN code chosen at random by scratching off his Multi-key card. Such PINs are temporary in nature. That means that upon entering the alphanumeric PIN code, the user has limited time to carry out the operation in question. This is one more security measure that tends to protect the system, restricting the degrees of liberty of a possible computer criminal.

Additionally, the PINs entered may have different colors according to the Business X categorization of the user, which adds one more element of control in the process of identity authentication that will be described below.

Once the NICK+PIN codes have been entered, the aforesaid AC Web server translates the alphanumerical chain into bar codes, within the EAN nomenclature and sends this code to the server without open connection, where the Authorization Center database is located.

As of this moment, all the operations of verification are without open connection, so that the only information that traveled by the web that would be intercepted were an isolated bar code of no use to any computer criminals.

Once the data has been transferred means of bar codes, the Web Server prints on a roll of wafers (A) the bar code with NICK+PIN information and a laser reader connected to the Authorization Center database reads the bar code barras and verifies that the NICK is qualified, that the PIN corresponds to the NICK and that the same PIN has not been used before. After this process of Verification, the printing of the bar codes on the roll of wafers (A) remains as a record of the transactions, which will be in the official monthly summary to Business X and/or to the AC, which-will list all the operations realized, by which users and using which PINs, along with the day, hour and other administrative data.

This verification is carried out by having access to a database that is not connected to the open network (by means of a process of laser reading of bar codes that contain the data to be validated), thus impeding access to this valuable information by means of the network.

It is appropriate to point out again that this is the novel point of the procedure, proposed, since all the operations of present systems always involve two points, both always being connected to the Web, allowing the computer science criminal to decode and steal information from the two points, which he can then use to commit the fraud that we are attempting to avoid here. In this procedure, one of the points is disconnected and the other consists of a series of unconnected data with no relation to either an account number or to any identifiable user.

Once the verification of the response to the request for recognition (legitimization of identity utilizing the same process as the foregoing but in reverse) has been accomplished the AC prints the bar code of that NICK+PIN with the Authorization or denial of the transaction on another roll of wafers (B). The laser reader connected to the AC Web Server reads this response and returns the response translated instantaneously and that combination of NICK+PIN are invalidated in the isolated and disconnected Agricultural Council database for the next operation. These printed wafers in the form of rolls, not only (A) but (B) serve as physical records of the transactions realized and kept administratively by the AC for the qualified companies that ask for them.

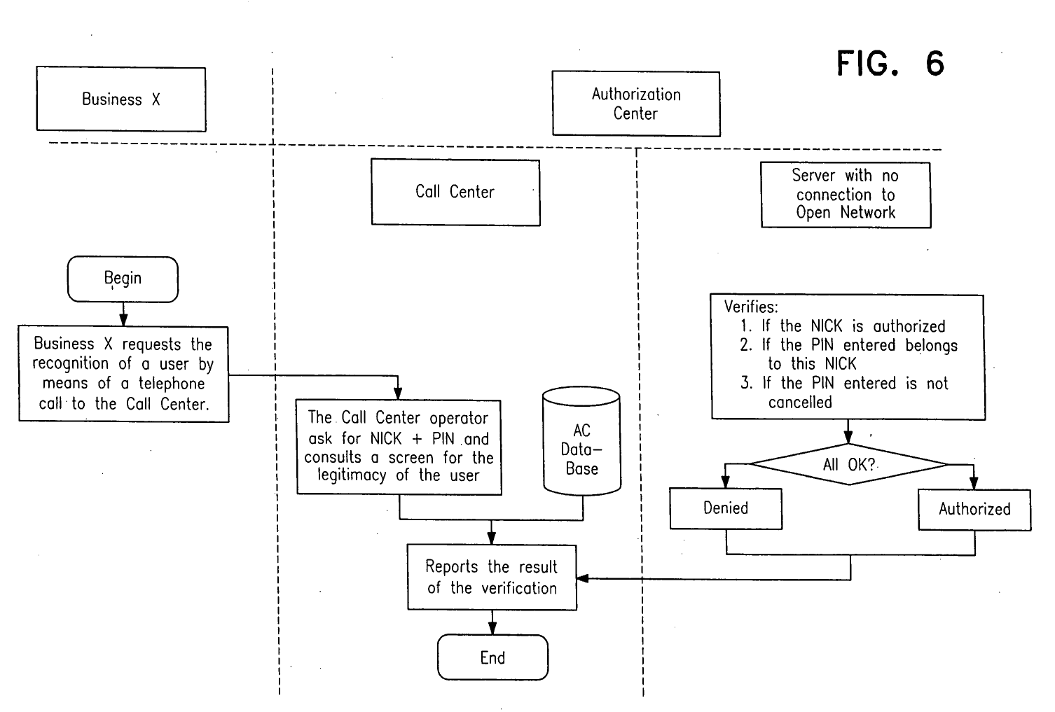

4.2 (FIG. 6): Authentication of Identity by Means of a Call Center

The Business X user wishes to operate with Business X and requests his legitimization by means of a telephone call to the Call Center. In this instance the Call Center operator requests the user's NICK+a PIN code from his Multi-key card and enters it on the system screen that provides verification of such data. The system verifies that the NICK is qualified; that the PIN corresponds to the NICK and that the aforesaid PIN has not been used before. As soon as the verification in response to the request for the recognition of identity has been accomplished, the use of the NICK+PIN combination in a future operation is invalidated.

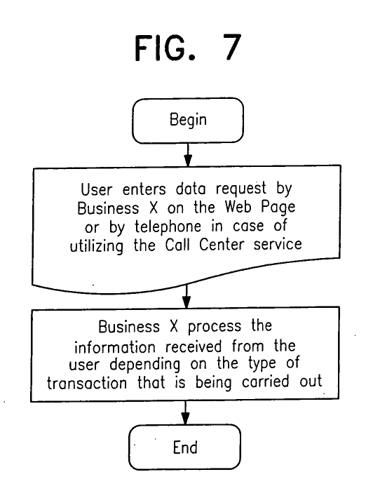

This verification is carried out by accessing the database that is not connected to the open network (by means of a telephone call to a Call Center), thus impeding access to this information by means of the network. As soon as the verification the response is given to the request for legitimization of identity.
Phase 5 (FIG. 7): Beginning of Internet Operations

Once the identity of the user has been established, the user is in condition, to undertake all types of operations or commercial transactions, to which end he will enter the data requested by Business X on their Web page or by telephone, in case of using the Call Center service. Business X will process the information received from the user, depending on the type of transaction that he desires to undertake, e-cash operations, for example, wholesale or retail e-commerce, home-banking, legitimization of medicines between laboratories, pharmacies and consumers, Call-Center: all direct or indirect commercial operations to authenticate the of a purchase card, credit card, debit card, social security card, health card, insurance card, etc. by way of traditional calls, for operations in Shopping Centers, Big Box Stores, etc., Security Hosting (Servers), to replace all type of passwords (Pin_Mail for example), control access a restricted areas, to authenticate test scores for university students (Multi-key card linked PC of a proctor, for example), to replace fixed PIN in Automatic tellers to withdraw money or other operations similar, to control various DGI operations, to control the sending of monetary remittances in a physical form, to give anonymity to clinical examinations of DNA and/or AIDS or others previously requested, etc.

The security procedure proposed having been completely described with details of each of its operative stages, it is clear that the present invention is not a mere economic commercial activity of a theoretical nature, but a procedure that presents a series of stages (actions) not evident to a person of average means, that tend to resolve a problem set forth in the state of the art based on a combination of elements such as software, hardware and the multi-key card with which all the operations are carried out.

More complete technical information is offered below with regard to how the invention will be carried out.

The key to the procedure claimed resides in the fact that it is supported by an Internet provider that manages its own network not connected to the others, with its own range of IP addresses managing its own routers with Border Gateway Protocol (BGP4) protocol. This BGP protocol allows the connection of a network of servers owned by multiple operators by two physical STM-1 fiber optical lines (155 Mbps each one of them), through which circulate the flows of multiple operator with high performance.

As mentioned before, the database is independent and separate from the mother trunk network of the Internet by means, of a laser connectivity that is produced as PINs enter converted by means of software into bar codes, which are read by optical readers that automatically locate the key to Authorization to continue with the transaction and certify it. Such readers can route more than 40 million packets per second in automatic mode.

In addition, the aforementioned internal network is completely interconnected by switches (there are no hubs) that are capable of managing a bar width greater than 180 Gbps.

A very important fact to keep in mind is that provider is of the Multihomed type, with its own Data Center; while the companies that offer dominions, hosting and lodging for servers at the present time lack security for the following reasons:
In the case of the telecommunications operators, they do not offer their own hosting, security and lodging products in their data centers. This brings the inconvenience that if these services are contracted, the client web site will be linked to the Internet by means of a single route, that of its operator.
From the point of view of connectivity telecommunications providers are mere appendices of the telecommunications operator of which provides them with the service; so that if the connection line of between the provider and his operator suffers a cut it will leave all their clients with no service.

In the case of procedure proposed, the Multihomed provider avoids this dependence by contracting bandwidth from different providers, giving value to the connectivity of each one of them. In this manner, each user connected to the Internet has multiple ways of arriving at the Web Sites hosted on the Web and the systems of routing of the Internet always choose the shortest route by themselves, so that the following advantages are obtained:
Physical redundancy: If one line is cut, the other maintains the Internet connection.
Velocity of discharge toward any destination: data packets choose the best rout to arrive at the user who is seeing the pages by the shortest route.
User security as the user does not have to hand over his personal data or other sensitive data or confidential information whatsoever to carry out a transaction by Internet.
User security as the user's identity, credit card No. And other sensitive data is protected, not to mention his credit capacity and other personal information.
The implementation of the procedure proposed will undoubtedly redound to greater confidence in the Web to operate on the Internet.

With respect to operating systems, the client can choose the operating system that he prefers in each one of the hosting security plan, they are Linux and Windows 2000 Server.

Servers based on Linux utilize the Apache Web server and provide the possibility of executing scripts in Perl, Pitón and PHP4, in addition to access to MySQL databases.

Windows servers incorporate the Internet Information Server and can host dynamic Web Sites utilizing ASP pages in Visual Basic Script with access to databases Access or SQL Server.

The hardware utilized in the two types of servers is IBM X330.

In summary, the procedure claimed provides the necessary requirements of patentability, in addition to not being included in the patentability exceptions specific to the patent law, since it deals with a series of necessary and consecutive stages to arrive at a final unpredictable result (not obvious to a person of ordinary skill in the art).

The software provided is not claimed “per se,” but it forms a part of a conjunction of elements that provide a desired “technical effect,” necessary to arrive at the aforementioned final effect and it interacts with the hardware specified. For that reason it is considered a patentable invention.

It is obvious various operational modifications can be introduced in the procedure described, as well as in the design and configuration of the card, without leaving the sphere of the present invention patent of what is clearly determined by the scope of the following claims.

1. A method to avoid Internet fraud that is carried out by means of a multi-key card in which a business organization, one or more users from the business organization and an authorization center interact, the method comprising the following steps:
requesting the legitimizing of the business organization to operate with the authorization center;
checking out the business organization in a database of the authorization center, assigning the business organization an identification code, said data base being not available on the Internet;
sending a list of the users to the authorization center;
preparing a registry assigning each user an alias or NICK and loading the registry into the database so that the new users are accepted;
requesting a specific number of multi-key cards for users qualified to operate by means of a note or purchase order;
generating in the authorization center a set consisting of the specific quantity of multi-key cards, assigning a unique number to each set and another unique number to each card, relating this card number with the user's NICK;
distributing the multi-key cards to the corresponding user personally and the cards including a form that possesses an organic security seal where the user must sign and leave the user's fingerprint;
updating information for the delivery of cards and returning the information and the form to the authorization center;
qualifying the NICK of the user who has received the multi-key card, thus up-dating the cards qualified; and
confirming the qualification to the recognized user,
wherein the method further comprises the following steps to authenticate user identity through a web page:
entering an official legitimized web page, the business organization requests entry to a portal of the authorization center by means of a link and, once entered therein, enters the NICK and a PIN of the multi-key card;
converting via an authorization center network server the NICK and the PIN to a bar code, and sending the bar code to the database of the authorization center, the database being without an open connection where a laser reader connected to the database reads the data and verifies whether the NICK is authorized, whether the PIN entered belongs to that NICK and whether the PIN entered has not been used before, authorizing the operation if all the verifications are positive or denying the operation if any of the verifications is negative;
the server without open connection shows the verification result and sends the result to the network server, where another laser reader connected to the network server reads the verification result, authorizing or denying the user's requested operation.

2. The method to avoid Internet fraud according to claim 1, characterized in that the following step for the authentication of user identity by means of a call center comprises:
requesting legitimization as the user by means of a telephone call to the call center,
in response to the call center operator the user reports the user's NICK and a PIN code from the user's multi-key card, data that will be entered by the operator into the system that makes the verification of such data available,
the system verifies that the NICK is qualified, that the PIN corresponds to the NICK and that the PIN has not been used, authorizing the operation if all the verifications are positive or denying the authorization if any of the verifications is negative;
once the verification has been effected, giving a response to the request for legitimization of identity to the user who requests it by telephone and invalidates further use of the NICK and PIN combination for a future operation.

3. The method to avoid Internet fraud according to claim 1, wherein the PIN entered by the user has limited temporary validity.

4. The method to avoid Internet fraud according to claim 1, wherein the PIN entered by the user has a color determined as a function of the category of the user who holds the card.

5. The method to avoid Internet fraud according to claim 1, wherein the step of generating the multi-key cards includes the additional steps of:
generating the cards in sets and assigning to each a unique alphanumeric card code of X characters (numbers, capital letters and/or lower-case letters), the system verifying that there is no identical code in the database that are not available on the network;
generating a random alphanumeric code of variable length that will be utilized as a PIN;
repeating the operation as many times as the multi-key card contains PINs so the system can verify that a PIN is not repeated in the same card;
assigning the user NICK to the code of the multi-key card and keeping the information in the database, thus authorizing this multi-key card.

6. A multi-key card to avoid Internet fraud to be used in accordance with the method of claim 1, characterized as being of a usual size as that of a magnetic card, having imprinted thereon the user's NICK, a variable series of PINs (alphanumeric codes) hidden by a scratch-off type protective cover, a unique set code identifier issued by the authorization center printer at the time of generating a specific set of cards for the business organization, and a card code identifier consisting of a unique alphanumeric code of X characters which identify that multi-key card, relating the card to the user and to the PINs that the user is authorized to use; as well as that the front of the card may contain space for advertising.

7. The multi-key card according to claim 6, characterized in that the NICK is printed on the multi-key card and hidden by a scratch-off type protective cover.

8. The multi-key card according to claim 6, characterized in that the NICK is printed on a removable plastic strip.

9. The multi-key card according to claim 6, characterized in that the multi-key card is wrapped in shrink-seal cellophane.
